(19) United States
(12) Patent Application Publication
(10) Pub. No.: US 2008/0282910 A1
(43) Pub. Date: Nov. 20, 2008

(54) Rechargeable hand-held rotary vegetable peeler

(76) Inventor: Fletcher Morgan, St. Petersburg, FL (US)

Correspondence Address: JOHN S. HALE;GIPPLE & HALE, 6665-A OLD DOMINION DRIVE, MCLEAN, VA, 22101, US

(21) Appl. No.: 11/798,414

(22) Filed: May 14, 2007

(51) Int. Cl. A23N 7/10; A23N 7/00; A47J 17/00; A47J 17/02; A47J 17/14; A47J 17/18

(52) U.S. Cl. 99/590; 99/588; 99/593

(57) ABSTRACT

An electrically powered apparatus for peeling vegetables and fruits having a handle housing containing a rotary electric motor with a rotatable output shaft, the output shaft being accessible from a distal end of the housing and a battery power source contained within the handle housing. A manually operable switch is mounted on the housing to operate the motor. A rotatable flexible peeler assembly is detachably connected to the output shaft for rotation by the shaft, with the flexible peeler assembly comprising a plurality of flexible blade members mounted to a cylindrical support base member and a cutting tip mounted to distal end of the support base member. Each flexible blade member is formed with a base portion which is mounted in the support base member and defines a plurality of transverse slits which extend away from the base portion to the outer edge of the blade member to form a plurality of flexible abrasive strips. A shield member is removably mounted to the handle housing, the shield defining an open lower section exposing the abrasive flexible strip and an open distal end through which the cutting tip extends.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### FIELD OF THE INVENTION

The present invention relates generally to hand held kitchen appliances, and more particularly, to a battery powered hand held rotary fruit and vegetable peeler.

### BACKGROUND OF THE INVENTION

Modern electrical appliances have made it more convenient to prepare foods in an efficient manner. It is not uncommon to find numerous electrical appliances in a kitchen, including blenders, mixers, food processors, bread makers, can openers and other devices to numerous to list. The reason for the popularity of these appliances is that consumers are constantly seeking products that make their lives easier by helping them complete their tasks better and more efficiently. One aspect of food preparation that consumes much time is peeling vegetables and fruits which is frequently done manually by using a knife or a standard kitchen peeler. The standard kitchen peeler has a metal or plastic handle attached to a long metal head which defines an elongated opening, the sides of the opening being sharpened to create a blade. The peeler is lowered to contact the fruit and/or vegetable skin surface and is then moved to cut and peel the skin away. There are numerous disadvantages to peeling fruits and vegetables in this manner. The individual must painstakingly carve the skin off one section at a time which is time consuming. If a large meal is being prepared, the peeling could take an excessive amount of time. Accordingly, it is desirable to have a device that can peel a variety vegetables and fruits in a time-efficient manner.

Another disadvantage of hand peeling is that it is tiresome to the hand and wrist. The person peeling the items must manually put sufficient pressure on the knife or peeler to separate the skin from the fruit or vegetable during the entire period of the peeling. Furthermore, the fingers must be wrapped tightly around the knife or peeler to ensure stable contact between the peeler and the item being peeled. The constant pressure combined with the fingers wrapped tightly around the knife or peeler strains the hand and wrist. A person who has weak or arthritic hands, wrists or fingers may be unable to manually peel vegetables or can do so only with extreme discomfort. Accordingly, it is desirable to have a peeling apparatus that does not strain the hand and wrist during the peeling process.

Another disadvantage of using a knife or the manual peeler is that the quality of the peeling depends upon the peeling capabilities of the person performing the task. An experienced peeler will probably be able to peel a fruit or a vegetable leaving little or no skin and with minimal removal of the body of the vegetable or the fruit. A less experienced peeler, however, is not as adept in using a knife or manual peeler. Therefore, the less experienced person would probably not be able to achieve a smooth, skinned surface resulting in a surface where chunks of skin can remain on the surface. This detracts from the taste and the aesthetic presentation of the food. Accordingly, it is desirable to have a device that would allow an inexperienced person to peel vegetables and fruits leaving a smooth, skinned surface.

Still another disadvantage of using a knife or manual peeler is that these tools can be unsafe around children as sharp edges of the knife and the blade of the hand peeler can cause substantial harm. Additionally, it is possible to cut oneself during the peeling process. Accordingly, it is desirable to have a peeling device that is safe to use for the person using it and safe to have around children.

There have been a number of attempts to develop improved fruit and vegetable peelers. One such prior art device is shown in U.S. Pat. No. 6,327,971 issued Dec. 11, 2001 which discloses a fruit and vegetable peeler having a blade mounted on a handle and a handle for supporting the blade along an outer surface of the fruit or vegetable.

Another peeler is shown in U.S. Pat. No. 4, 972,769 issued Nov. 27, 1990 in which an externally powered motor encased in a housing drives paddle type rotors about an axis which is perpendicular to the surface of the fruit or vegetable to be peeled. It is noted that this peeler can be also provided with a rechargeable battery.

U.S. Pat. No. 4,656,936 issued Apr. 14, 1987 discloses a fruit and vegetable peeler having a rotary cutting element which is mounted within a protective housing and is selectively driven by an electric motor. The cutting element is in the form of angled inclined fixed metal blades positioned beneath adjustable food guide plate which are longitudinally moveable with respect to the cutting element.

A rotary electrical peeling device is shown in U.S. Pat. No. 6,186,058 issued Feb. 13, 2001. This device has a housing with a motor mounted therein, the motor being externally powered via an electrical cable which is engageable in an electrical power outlet. As is noted in the patent, the device does not rely on the use of electric storage batteries. The device uses different peeler heads, each of which has an attachment shaft to hold the peeler head firmly in place in the motor shaft. A removable shield having an open end is snap fit over the motor housing and the peeler head. The peeler head is cylindrical or bullet shaped and has an exterior surface that has an uneven texture of selected roughness. Sand is preferably used for the abrasive material to cover the peeler heads and different heads covered with different sand sizes are used, for example, in peeling carrots or peeling potatoes. As the peeler head rotates, the head surface interacts with the outside skin surface of a fruit or vegetable and peels it by abrading.

Another attempt at an improved device is a machine that has been marketed extensively on television. In this device, the fruit or vegetable is mounted on a stand. A spring-loaded arm having a small scoop at the end, contacts the fruit or vegetable mounted on the stand. The scoop at the end of the spring-loaded arm has a sharp circumference. A hand crank is rotated causing the fruit or vegetable to rotate on the stand. As the fruit or vegetable rotates, the small scoop, takes off the top layer. Consumers have a limited amount of cabinet or counter space available for new products and this product takes up significant space. It is desirable to have a small device that does not take up an excessive amount of room in the kitchen. A second problem with this device is that it scoops out more than just the skin layer. When the peeling is completed, grooves can be observed in the fruit or vegetable. Also, some of the fruit and vegetable is wasted as it is scooped out along with the skin. Accordingly, it is desirable to have a device that does not leave unsightly grooves in the fruits and vegetables and only peels away the skin.

### SUMMARY OF THE INVENTION

The above and other objects, feature and advantages of the present invention will be apparent in the following detailed description thereof when read in conjunction with the appended drawings wherein the same reference numerals denote the same or similar parts throughout the several views.

The present invention is a kitchen appliance for abrasively peeling vegetables, fruits and the like having a battery powered rotary electric motor with a drive shaft, a sealed handle housing enclosing the motor and a manually operable switch to start and stop the motor. A peeler utility assembly is detachably mounted to the motor drive shaft for rotation by the motor shaft. The peeler cutting assembly is flexible and is formed with a plurality of strips of abrasive material mounted on a cylindrical support base with the proximal end of the support base receiving a drive shaft and the distal end having a bullet shaped cutting tip mounted thereto. A shield member with an open distal end and open bottom is mounted to the handle housing and is positioned over the peeler assembly.

The present invention addresses the needs and deficiencies noted above. It provides a small electrically-powered kitchen appliance which is sufficiently small in size that it can be held easily in one hand in a way which is convenient, comfortable and effective for the user.

It is an object of the invention to provide an appliance in which effective use is not dependent upon a high, or even moderate, level of user experience.

It is another object of the invention that it operates to effectively remove the skin of a vegetable or a fruit without appreciable removal of the body of the vegetable or fruit.

It is still another object of the invention that the motor and batteries be sealed from juices of the peeled fruits and vegetables.

It is yet another object of the invention that it can be easily washed and broken apart for dishwasher use and cleaning.

### BRIEF DESCRIPTION OF THE DRAWINGS

The invention will be better understood and objects other than those set forth above will become apparent when consideration is given to the following detailed description thereof. Such description makes reference to the annexed drawings wherein.

FIG. 1 is a side elevation view of the inventive peeler assembly;

FIG. 2 is a front elevation view of the peeler assembly shown in FIG. 1;

FIG. 3 is a perspective view of the peeler assembly shown in FIG. 1;

FIG. 4 is a top plan view of the peeler assembly shown in FIG. 1;

FIG. 5 is a cross sectional view of the peeler assembly shown in FIG. 4 taken along line 5′-5′;

FIG. 6 is a perspective view of the handle holding the battery supply and motor for the peeler assembly shown in FIG. 3;

FIG. 7 is a side elevation view of the handle for the peeler assembly shown in FIG. 6;

FIG. 8 is a rear elevation view of the peeler assembly housing shown in FIG. 7;

FIG. 9 is a front elevation view of the peeler assembly handle shown in FIG. 7;

FIG. 10 is a top plan view of the peeler assembly handle shown in FIG. 7;

FIG. 11 is a reversed perspective view of the peeler shield;

FIG. 12 is a side elevation view of the peeler shield shown in FIG. 11;

FIG. 13 is a bottom plan view of the peeler shield shown in FIG. 12;

FIG. 14 is a front elevation view of the peeler shield shown in FIG. 11;

FIG. 15 is a perspective view of the peeler blade assembly;

FIG. 16 is a reversed perspective view of the peeler blade assembly shown in FIG. 15;

FIG. 17 is an enlarged side elevation view of the peeler blade assembly shown in FIG. 15;

FIG. 18 is a front elevation view of the peeler blade assembly shown in FIG. 17;

FIG. 19 is an enlarged side elevation view of the peeler blade assembly base support;

FIG. 20 is a front elevation view of the distal end of the peeler blade assembly base support shown in FIG. 19;

FIG. 21 is a rear elevation view of the proximal end of the peeler blade assembly base support shown in FIG. 19;

FIG. 22 is a cross section view of the peeler blade assembly base support shown in FIG. 19 showing insertion of the motor shaft in the base support;

FIG. 23 is an enlarged side elevation view of the peeler blade assembly cutting tip; and

FIG. 24 is a cross section of the peeler blade assembly cutting tip taken along line 24′-24′ in FIG. 23.

### DETAILED DESCRIPTION OF THE INVENTION

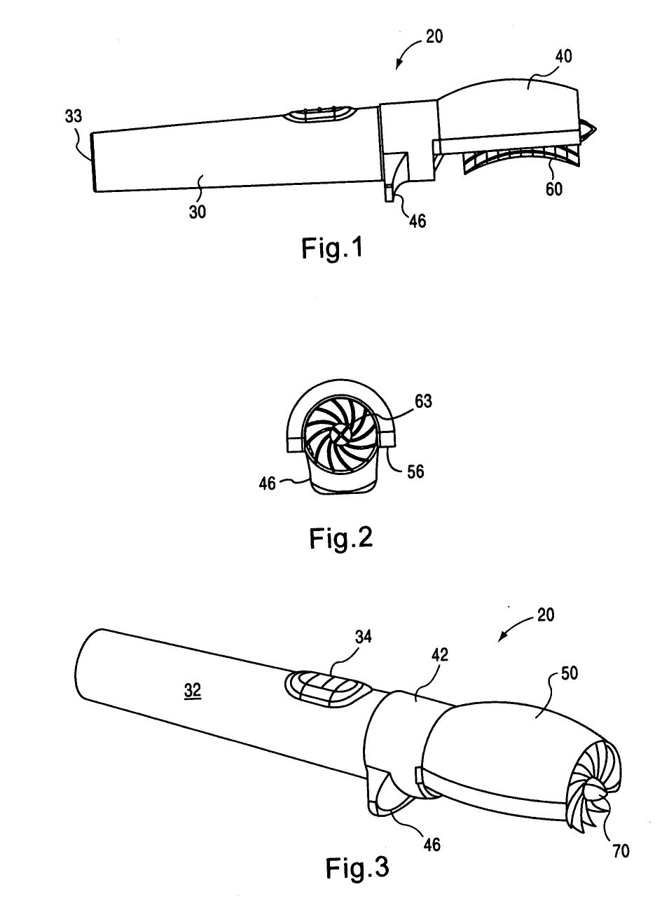

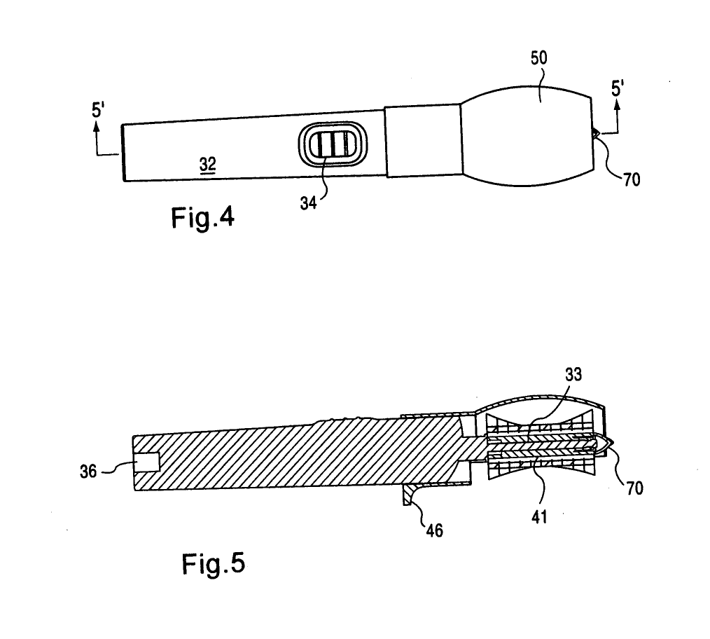

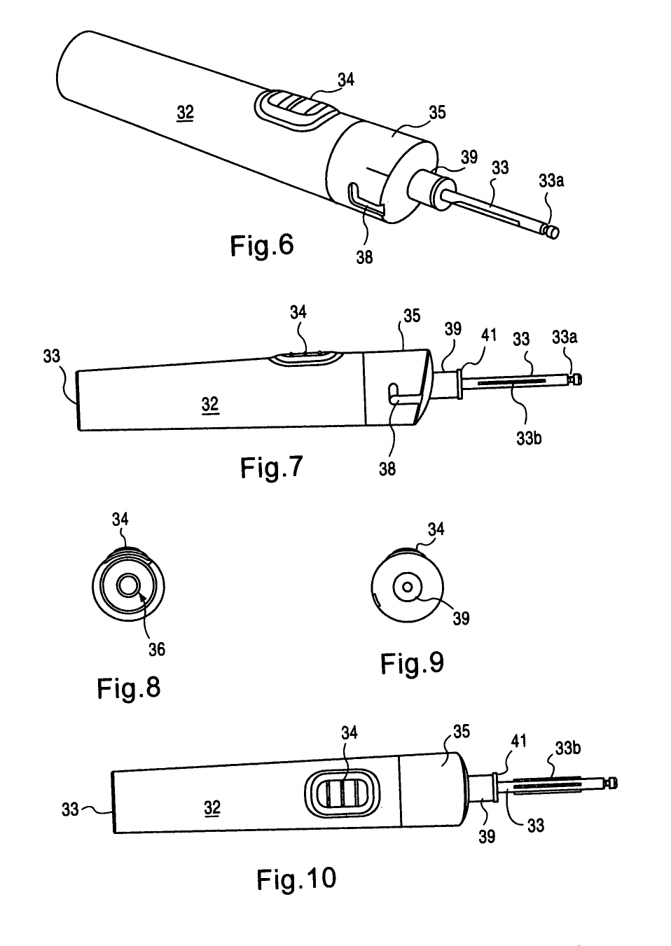

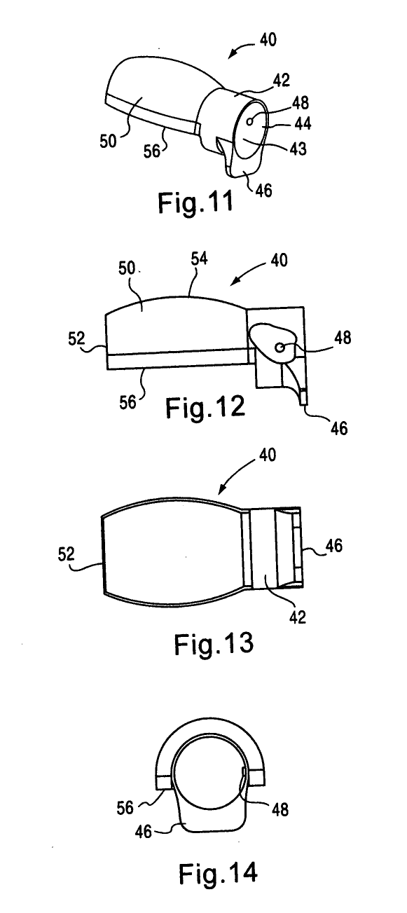

The preferred embodiment and best mode of the invention is shown in FIGS. 1 through 24. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

The present invention generally refers to a fruit and vegetable peeler apparatus 20 constructed with a handle 30, a removable shield member 40 and a rotating peeler blade assembly 60. The handle 30 is a slightly tapered cylindrical housing 32 with a manual on-off switch 34 mounted in the top forward section of the housing 32. The switch 34 operates a motor (not shown) which is powered by rechargeable batteries (not shown) as, for example, lithium batteries mounted in the housing which transmits power to the motor which in turn drives drive shaft 33. The shaft 33 has a plurality of longitudinal splines 33b which fit into internal grooves 62 formed in the peeler blade support base member 61 as seen in FIGS. 21 and 22. The distal end of shaft 33 has a circumferential beveled groove 33a which forms a detent to receive the rib 69 of snap on peeler blade support base member as seen in FIG. 22. The batteries and motor are standard off the shelf articles and can be seen in any number of battery powered devices and the relationship of each within a cylindrical housing is well known in the art. All of the electrical components including the motor are enclosed in waterproof material such as a sealed plastic sheath eliminating any potential for water to contact any electrical component or connection. The proximal end 33 of the housing 32 is formed with a charge port 36 as shown in FIGS. 5 and 8 which receives the end of a charger device which is also known in the art to recharge the batteries in the housing. The distal end 35 of the housing 32 is formed with a bayonet locking groove 38 which receives a locking pin 48 from the peeler shield member 40 to hold the same in a fixed locked position on the housing 32 as shown in FIGS. 1 and 3. A guide collar 39 extends from the front or distal end of the housing 32 to receive the base support member 61 of the peeler blade assembly 50 and is seated inside proximal end chamber 65 of the base support member 61. A bushing 41 is mounted on the distal end of collar 39 and provides a surface on which distal end 61a of the base support member 61 rotates. The shaft 33 is snapped into place by internal beveled circular rib 69 of the support base 61 camming into beveled groove 33a of the shaft 33. The rib 69 has sides which are angled at 45° and a flat planar top which are cammed into groove 33a and are seated into groove 33a.

As previously noted, shield member 40 is mounted to the housing 32 by placing locking pin 48 which is best shown in FIGS. 1 land 14 into the locking groove 38, sliding the shield member rearward and then turning the shield and locking the base section 42 of the shield member to the housing 32. The shield member 40 is formed with a base section 42 in the form of a cylinder having an open end 44 which slips over the outer surface of the front or distal end 35 of the handle housing 32. The shield member 40 has a finger support bar 46 extending therefrom which allows the user to easily guide the peeler assembly during use. The shield member 40 is preferably made of plastic and can be transparent or opaque. Locking pin 48 extends inward into the cylindrical chamber 43 of the base section allowing the shield member 40 to be locked onto the housing 32 as previously described. A peeler blade cover section 50 is integrally formed with the base section 42. The peeler blade cover section 50 is generally semicircular in cross section with an open front end 52 and a curved outward exterior wall 54 which bulges upward. The bottom end of the exterior wall 54 is open and the ends of the exterior wall terminate in a bottom planar surface 56 as is shown in FIGS. 1, 12 and 14.

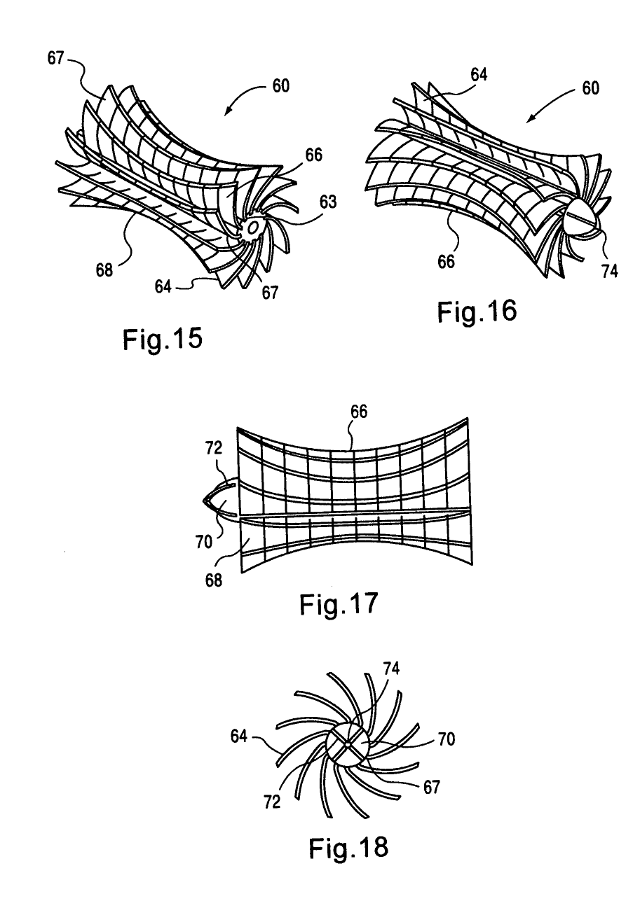

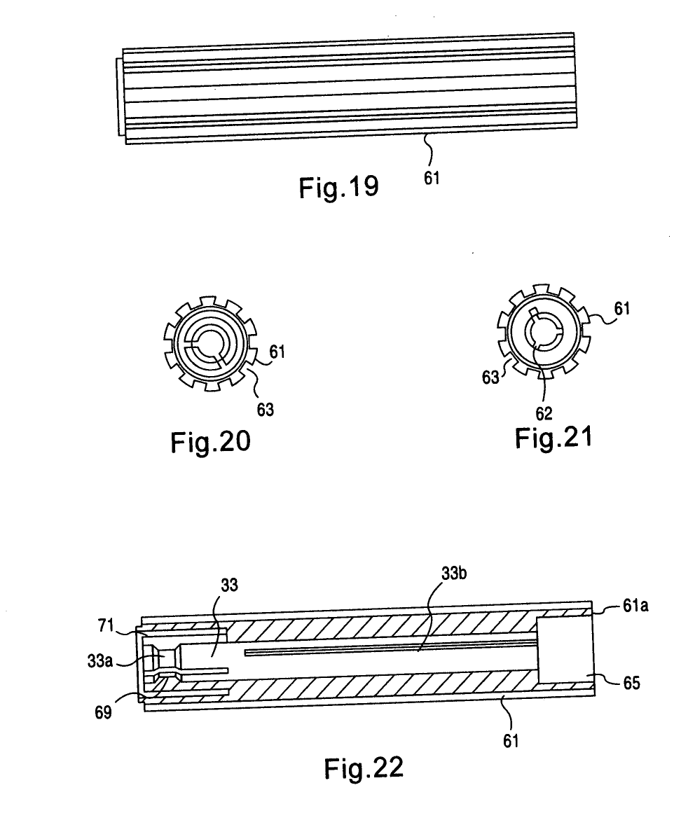

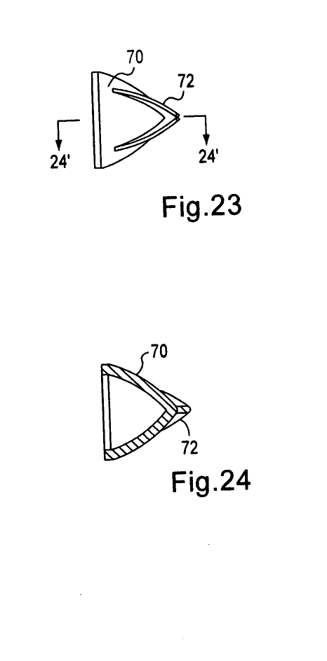

The peeler blade assembly 60 as shown in FIGS. 15-24 is constructed with a slotted cylindrical support body 61 constructed of plastic or other suitable material which holds a plurality of abrasive flexible peeler flaps 64 mounted in the slots 63 cut longitudinally into the exterior surface of the cylindrical support body 61. Slots 63 are shown in FIGS. 19-21. Each peeler flap 64 is flexible and has an inwardly curved outer surface 66 and is formed with a plurality of spaced cuts 68 cut transverse to the axis of the cylindrical support body 61 and extending to the outer edge of the flap forming individual cutting strips 67. It will be appreciated that the cuts 68 do not extend through the width of the peeler flap 64 leaving a small solid continuous section at the base of the flap 64 next to the slot 63 in which it is mounted. The peeler flaps 64 are preferably constructed from 32 to 40 grit emery cloth, most preferably 40 grit emery cloth and are evenly spaced around the cylindrical support body 61. While 10 flaps equally spaced around the circumference of the support base 61 are shown, any number of flaps ranging from 4 to 16 or more can be used. The flaps 64 are preferably adhesively mounted in the slots 63 but they can be formed with a plastic base and heat sealed onto the cylindrical support body 61. Alternatively they can be mounted in a tongue and groove type construction or in a bead and groove construction. A coring tip 70 is mounted in the distal end of support body 61 in a blind circumferential groove 71. The tip 70 has a rounded conical form or bullet shape and has cutting blades 72 formed thereupon as shown in FIGS. 23 and 24 and ends with a rounded conical or bullet shaped point 74. The tip 70 can be used for specific cutting in localized areas such as removing the eyes from potatoes or blemish areas from apples and the like. The cutting flaps 64 with the inwardly curved outer edge 66 forms a contoured edge allowing uniform abrasion of uneven rounded surfaces are found on vegetables and fruits.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. An electrically powered apparatus for peeling vegetables and fruits and comprising:
a handle housing having a rotary electric motor with a rotatable output shaft mounted thereto and a battery power source to drive said electric motor contained within said handle housing;
a manually operable switch mounted on said handle housing, the switch being operable to control operation of the motor;
a flexible peeler assembly detachably connected to said output shaft for rotation by the shaft, said flexible peeler assembly comprising a support member, and a plurality of flexible blade members mounted to said support member; and
a shield member removably mounted to said handle housing, said shield member defining an open lower section allowing engagement of said flexible blade member with an item being peeled

2. The apparatus of claim 1 wherein said battery power source is a rechargeable battery and said handle housing is provided with a charging port.

3. The apparatus of claim 1 wherein said shield member has a finger grip projection extending therefrom.

4. The apparatus of claim 1 wherein each flexible blade member has an abrasive surface and has a solid continuous section with a plurality of flexible strips extending from said solid continuous section.

5. The apparatus of claim 1 wherein said peeler assembly support means has a distal end which is bullet shaped and has at least one cutting blade.

6. The apparatus of claim 1 in which each flexible blade member defines an inwardly curved outer exterior edge.

7. The apparatus of claim 1 wherein said peeler assembly comprises a base support member defining a plurality of longitudinal slots, a flexible blade member mounted in a slot, said flexible blade member defining a plurality of slits transverse to the axis of said base support member which extend away from said base support member to the outer edge of said blade member to form a plurality of flexible strips, each flexible strip being coated with an abrasive material.

8. The apparatus of claim 7 wherein each flexible blade member is coated with an abrasive material ranging between 32 and 40 grit.

9. The apparatus of claim 8 wherein said abrasive material is emery grit and said blade member is constructed of emery cloth having 40 grit.

10. An electrically powered apparatus for peeling vegetables and fruits and comprising:
a handle housing having a rotary electric motor with a rotatable output shaft mounted therein, a battery power source contained within said handle housing and electrically connected to said electric motor, said handle being provided with a recharging port at its distal end electrically connected with said battery power source;
a manually operable switch mounted on said housing and connected to the motor, said switch being operable to control operation of the motor;
a rotatable flexible peeler assembly detachably connected to the motor output shaft for rotation by said shaft, said flexible peeler assembly comprising a cylindrical base support member, a plurality of flexible blade members mounted to said base member, a tip member mounted to a distal end of said base support member; and
a shield removably mounted to said handle housing, said shield comprising a housing with mounting means on its proximal end section, a curved section defining an open lower section and an open distal end.

11. The apparatus of claim 10 in which each flexible blade member defines an inwardly curved outer edge.

12. The apparatus of claim 10 wherein said shield is constructed of transparent plastic.

13. The apparatus of claim 12 wherein each flexible blade member comprises a base section which is mounted in said base member and a blade section, said blade section defines a plurality of slits transverse to the axis of said base section which extend away from said base section to the outer edge of said blade section to form a plurality of flexible strips for each blade member.

14. The apparatus of claim 13 wherein each flexible blade member is coated with an abrasive material.

15. The apparatus of claim 13 wherein said abrasive material runs from 30 to 40 grit.

16. An electrically powered apparatus for abrasively peeling vegetables and fruits and comprising:
a handle housing having a rotary electric motor having a rotatable output shaft mounted thereto extending outside said handle housing;
a rotatable flexible peeler assembly detachably connected to the shaft for rotation by the shaft, said flexible peeler assembly comprising a support member, a coupling means defined by said support member allowing said support member to be coupled with said output shaft, a plurality of flexible blade members mounted to said support member, each flexible blade member comprising a base section which is mounted to said support member and blade section adjacent said base section defining a plurality of slits which extend away from said base portion to the outer edge of said blade section to form a plurality of separated flexible strips, said flexible strips being covered with an abrasive substance; and
a shield member removably mounted to said handle housing, said shield member defining an open lower section and an open distal end allowing said peeler assembly blade section to extend therefrom, said shield being provided with lock means to engage and lock on said handle housing.

17. The apparatus of claim 16 in which each flexible blade member defines an inwardly curved outer surface.

18. The apparatus of claim 16 wherein said flexible blade member is constructed of emery cloth.

19. The apparatus of claim 16 wherein said support member has a bullet shaped cutting tip mounted thereto on its distal end.

20. The apparatus of claim 16 wherein said support member defines a plurality of longitudinal grooves on its outer surface dimensional to receive a base section of said flexible blade member.

21. The apparatus of claim 19 wherein said bullet shaped tip member defines a plurality of cutting edges.

22. The apparatus of claim 16 wherein said shield member is disposed substantially coaxially of and partially enclosing the peeler assembly, the shield member being open along one side thereof for lateral access to the peeler assembly and being open at its end opposite from the motor housing and beyond which a portion of the peeler assembly extends.
